(19) United States
(12) Patent Application Publication
(10) Pub. No.: US 2025/0027794 A1
(43) Pub. Date: Jan. 23, 2025

(54) MOVEMENT MEASUREMENT SYSTEM WITH METHOD FOR REDUCING INTERPOLATION ERROR

(71) Applicant: NanoWave Incorporated, Needham, MA (US)

(72) Inventor: Tetsuo Ohara, Acton, MA (US)

(21) Appl. No.: 18/774,200

(22) Filed: Jul. 16, 2024

Related U.S. Application Data
(60) Provisional application No. 63/527,191, filed on Jul. 17, 2023.

(51) Int. Cl. G01D 5/26

(52) U.S. Cl. CPC G01D 5/26

(57) ABSTRACT

A system for measuring movement along a designated travel path includes an encoder assembly with a pair of encoder heads maintained a fixed distance apart. The encoder assembly is designed to simultaneously compile pairs of position measurements relative to a main track, with each encoder head utilizing a unique scale pitch. A signal processing unit in communication with the encoder assembly converts each pair of position measurements into the spatial domain and maps the calculated distance between position measurements. The signal processing unit identifies patterns in the mapped data which are directly attributable to interpolation error, for example, by performing either a fast Fourier transform or a discrete Fourier transform on the mapped data to yield spatial frequency peaks. Thereafter, the signal processing unit can filter out mapped data at the peak frequencies to minimize errors that may otherwise compromise encoder measurement accuracy.

### CROSS-REFERENCE TO RELATED APPLICATIONS

The present invention claims the benefit under 35 U.S.C. 119 (e) to U.S. Provisional Patent Application No. 63/527,191, which was filed on Jul. 17, 2023, in the name of Tetsuo Ohara.

### FIELD OF THE INVENTION

The present invention relates generally to the field of position encoding devices and, more particularly, to techniques for reducing interpolation error in position encoding devices.

### BACKGROUND OF THE INVENTION

A position encoding device, or position encoder, is a sensing device that is designed to convert any detected linear or rotational movement into an encoded output signal, especially when long range or high-resolution measurement is required with great precision and accuracy. In turn, the encoded output signal can be utilized to calculate, inter alia, the position, speed, and/or acceleration of objects, which would be indicative of the final measurement information, in applications including but not limited to measurement of force, gyration, strain, or weight. For this reason, position encoding devices are commonly used in a wide range of conventional applications, including industrial automation, robotics, and medical devices.

Position encoders can be created using optical, capacitance, magnetic, and other sensing means. Generally, the methods of reducing errors are independent of the sensing means, and encoders using optical sensing means are described here only as an example. Similarly, some encoders, called incremental encoders, measure only a change in position and require initialization to determine a reference position, whereas other encoders, called absolute encoders, report an absolute position and do not require initialization. The methods of reducing error sources disclosed herein apply equally to all these types of encoders, even though optical incremental encoders are used, as an example, to explain the invention.

An optical encoder is one well-known type of position encoder that relies upon the principles of interference, reflectance, or transmission of light in order to measure movement. For instance, one conventional form of an optical encoder includes a light source, such as a light-emitting diode, that produces light which is preferably collimated by a lens, or other similar optical device. The collimated light may be directed through a grating, or mask, constructed with an array of parallel slits spaced evenly apart at a pre-defined pitch. Such a grating may be referred to as an index mask. The result is a reference pattern that shines on the scale, as explained below.

In the case of a reflection type position encoder, light transmitted through the index grating is directed onto a main grating, or track, which is separate from the encoder. The track is provided with an array of parallel elements of high reflectance separated by regions of low reflectance at a fixed pitch which is typically matched to the pitch of the index grating. Light reflected from the track is directed onto a photodetector in the optical encoder. As the scale moves in relation to the encoder head, photodetector output signal changes.

As can be appreciated, either the optical encoder or the track is designed to move relative to the other, which remains fixed. Movement creates an intermittent transmission or reflection of light onto the photodetector with a pattern that directly corresponds to the scale pitch of the main track. Typically, the photodetector outputs, which may be called A and B, are converted from the differential outputs, A+, A−, B+, and B−, by electronics that are housed in or outside the encoder heads.

A simple position encoder that is constructed with a single photodetector is only able to detect movement independent of direction. For instance, an encoder designed to measure rotational movement is only able to measure angular displacement without knowledge of the particular direction of movement (i.e., in the clockwise or counterclockwise direction).

Accordingly, an incremental, or sine/cosine-type encoder, also called a quadrature encoder, is a position encoding device that includes a pair of photodetectors maintained 90 degrees apart from one another in phase. Upon detecting movement, an incremental encoder generates two output signals, A(t) and B(t), one from each of its photodetectors. The output signals are typically generated sine waveforms which are shifted 90 degrees in phase. The phase difference between the pair of output signals is either positive or negative depending on the direction of movement. Because the signals A(t) and B(t) are periodic functions whose phase relationship is unique for each direction of movement, the pair of output signals can therefore be utilized to determine both the degree of movement as well as direction.

Examples of encoders are disclosed in U.S. Pat. No. 5,589,686 to T. Ohara, U.S. Pat. No. 5,744,799 to T. Ohara, U.S. Pat. No. 6,639,686 to T. Ohara, and U.S. Pat. No. 7,430,484 to T. Ohara, the disclosures of which are incorporated herein by reference.

One factor in determining the resolution of an incremental encoder is the scale pitch, or period, of the main grating. Notably, a position encoder that utilizes a main grating with a relatively large period (e.g., ˜100 um) provides only a limited degree of accuracy and is therefore relatively inexpensive to implement. By contrast, a position encoder with a main grating with a relatively short period (e.g., less than 20 um) provides higher overall accuracy and performance but, at the same time, is more difficult to manufacture which increases overall implementation costs.

In the case of a quadrature encoder, the outputs are assumed to be sinusoidal, and the following mathematical process of interpolation is used to estimate intermediate values over movement of one grating pitch.

The quadrature outputs from a position encoder can be ideally modelled or represented using the following formulas:

A(t)=C(t)*sin(θ(t))+Va(t) (1)

B(t)=D(t)*cos(θ(t)+α)+Vb(t)=D(t)*{cos(θ(t))*cos(α)−sin(θ(t))*sin(α)}+Vb(t)˜D(t)*{cos(θ(t))−sin (θ(t))*α}+Vb(t) (2)

wherein each of Va(t) and Vb(t) is the bias signal contained in its respective quadrature output, C(t) and D(t) represent the amplitudes of each quadrature signal, and a is the relative error in phase deviation from 90 degrees between the quadrature outputs, A(t) and B(t). Ideally, phase deviation error α and bias signals Va(t) and Vb(t) should be zero, and amplitudes C(t) and D(t) should be the same value. Using the above-identified models, position as phase θ(t) within the main scale period can be determined by simply calculating the arctangent of outputs (A(t)/B(t)).

Because the photodetector outputs are not pure sine waves nor the same signal amplitude at the same bias, the interpolation process has been found to introduce interpolation error. It is an error between the calculated and actual position within a single grating period of the scale, therefore creating periodic error which repeats over one scale period. The amount of interpolation error is typically directly proportional to the size of the scale pitch for the encoder. This is an empirical finding, and the amount of error is different for different implementations.

Interpolation error generally occurs as periodic errors due a wide range of different factors including, but not limited to, an imbalance between output signal amplitudes C(t) and D(t), scale pitch periodicity error, non-zero bias signals Va(t) and/or Vb(t), non-zero phase deviation error α between output signals, index, and irregularities in the scale and grating manufacturing processes.

Additionally, encoders have other non-periodic sources of error when measuring along the entire usable length of the scale. Such errors may include, but are not limited to, non-uniformity of the grating period along its length, bending of the scale, and various temperature effects. These error sources may be referred to as other sources of error. These other sources of error may also be referred to as low spatial frequency interpolation error due to the locally distributed conditions of the scale parameters mentioned above.

The presence of interpolation error can significantly compromise the overall accuracy of an incremental encoder. As can be appreciated, these measurement inaccuracies, even if relatively small, can significantly jeopardize the overall performance of an encoder within a designated system, particularly when utilized in high-precision applications.

For example, in FIG. 1, there is shown a graph depicting actual interpolation error measured using a conventional low-cost encoder head with a scale period of 80 um as compared to similar position measurements compiled using a commercially available high-end position encoder output with scale period of 2 um and better than 2 nm pp interpolation error, the graph being represented generally by reference numeral 10. As can be seen, a conventional low-cost encoder experiences as high as 1.5 um peak-to-peak periodic error in its position readings with up to 3 um peak-to-peak level of non-periodic error in its position readings.

Inexpensive quadrature encoders with reasonable performance and low cost are now available as single integrated circuits from various manufacturers. Similarly, the cost of digital signal processing is constantly being reduced. Thus, the use of low-cost encoder ICs, combined with low cost signal processing, results in high performance position encoders that are less expensive than available via conventional means.

### SUMMARY OF THE INVENTION

It is an object of the present invention to provide a new and improved system and method for measuring movement along a travel path.

It is another object of the present invention to provide a system and method as described above which is designed to measure movement along a travel path with great precision and accuracy.

It is another object of the present invention to provide a system and method as described above which is designed to minimize the presence of interpolation error in its algorithmic processes.

It is another object of the present invention to provide encoder outputs that are suitable for use with the system and method of minimizing interpolation error.

It is still another object of the present invention to provide a system and method as described above which can be easily constructed and inexpensively implemented.

Accordingly, as one feature of the present invention, there is provided a system for measuring movement along a travel path, the system comprising (a) an encoder assembly positioned relative to a main track, one of the encoder assembly and the main track being configured to move relative to the other along the travel path, the encoder assembly comprising, (i) a first encoder configured to generate position measurements relative to the main track, and (ii) a second encoder offset from the first encoder a fixed distance relative to the travel path, the second encoder being configured to generate position measurements relative to the main track, (iii) wherein the first and second encoders concurrently generate pairs of position measurements in the time domain based on the position of the encoder assembly relative to the main track, and (b) a signal processing unit in electrical communication with the encoder assembly, (c) wherein the signal processing unit converts the pairs of position measurements in the time domain into corresponding position measurements in the spatial domain, the signal processing unit creating a map of the difference between each pair of position measurements in the spatial domain throughout the travel path, the map including periodic patterns which are directly attributable to interpolation error.

Various other features and advantages will appear from the description to follow. In the description, reference is made to the accompanying drawings which form a part thereof, and is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is a graph depicting actual interpolation error measured using a conventional low-cost encoder head with a scale period of 80 um;

FIG. 2 is a simplified schematic representation of a first embodiment of a system for measuring movement along a travel path, the system being constructed according to the teachings of the present invention;

FIG. 3 is a more detailed schematic representation of the encoder assembly and the main track shown in FIG. 2;

FIG. 4 is a simplified flow chart depicting a novel method for reducing interpolation error from measurement data compiled using the system shown in FIG. 2, the method being implemented according to the teachings of the present invention;

FIG. 5 is a simplified flow chart of the initial position estimation step in FIG. 4, which details the process in which quadrature signals provided from each encoder head are preferably preconditioned in order to initially remove certain types of interpolation error from the measurement data;

FIG. 6 is a graph depicting the actual reduction in measured periodic interpolation error achieved as a result of applying initial position estimation step in FIG. 5;

FIG. 7 is a graph depicting actual test data of the measured mutual distance between a pair of fixed encoder heads of the type shown in FIG. 3 throughout a designated travel path;

FIG. 8 is a simplified flow chart of the interpolation error identification and elimination step in FIG. 4, which details the process in which measurement data is mapped in the spatial domain in order to identify and eliminate any residual interpolation error;

FIG. 9 is a graph depicting actual memory-mapped contents of data collected in FIG. 7 after subtracting a low spatial frequency error;

FIG. 10 is a first plot of measurement data mapped as part of the interpolation error identification step shown in FIG. 8, the mapped data being applied with a fast Fourier transform (FFT) in order to facilitate identification of certain types of interpolation error;

FIG. 11 is a second plot of measurement data mapped as part of the interpolation error identification step shown in FIG. 8;

FIG. 12 is a data graph of actual test results obtained from applying the method for reducing interpolation error from measurement data shown in FIG. 4;

FIG. 13 illustrates the differential outputs generated by a typical detector array inside a single head sine/cosine position encoder;

FIG. 14 illustrates a pair of signal processing processes that effectively creates two position encoder units from a single conventional position encoder head;

FIG. 15 is a photograph which depicts a fine fringe projected onto a MEMS atomic force microscope (AFM) cantilever through a microscope objective lens;

FIG. 16 is a simplified representation of a micro-electromechanical systems (MEMS) gyroscope sensor that is applied with the interpolation error reduction techniques of the present invention;

FIG. 17 is a schematic representation of an analog multiplexer that is configured to implement a novel time-multiplexing method; and

FIG. 18 is a signal processing model that assists in illustrating the designed operation of the analog multiplexer shown in FIG. 17.

### DETAILED DESCRIPTION OF THE INVENTION

### Movement Measurement System 11

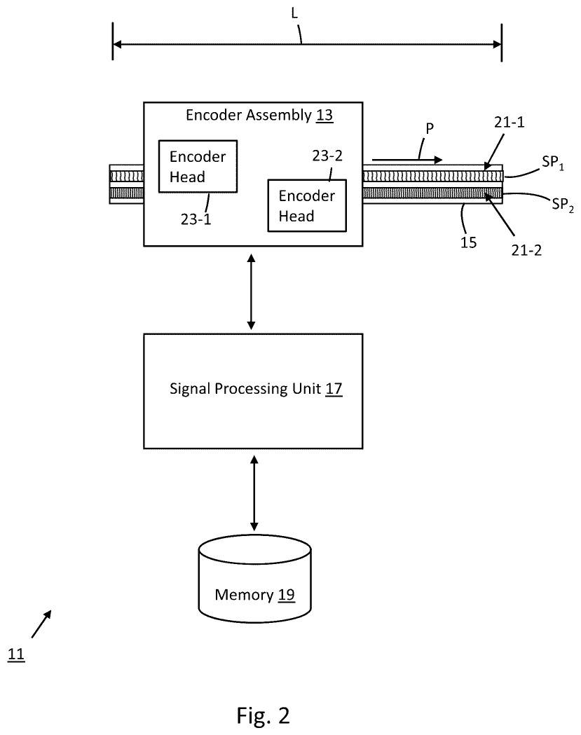

Referring now to FIG. 2, there is shown a simplified schematic representation of a novel system for measuring movement, the system being constructed according to the teachings of the present invention and defined generally by reference numeral 11. As will be described in detail below, system 11 is uniquely designed to implement a novel signal processing technique for reducing periodic interpolation error as well as other forms of non-periodic measurement error, thereby improving the overall accuracy of its measurements.

As can be seen, movement measurement system 11 comprises (i) a dual-encoder head, or encoder assembly, 13 adapted to move relative to a main track 15 along a travel path P which extends a defined measurement length L, (ii) a signal processing unit 17 in electrical communication with encoder assembly 13 for compiling and processing position measurement data from encoder assembly 13 in order to identify and subsequently filter interpolation error from such data, and (iii) memory 19 in electrical communication with signal processing unit 17 for storing, inter alia, position measurement data prior to and subsequent to error compensation. As will be explained in detail below, signal processing unit 17 engages in an iterative measurement correction process to continuously refine position measurement data and thereby yield, in real time, the most accurate measurement information.

Main track 15 is represented herein as comprising a first measurement scale 21-1 of a first scale pitch SP₁ and a second measurement scale 21-2 of a second scale pitch SP₂, the first and second measurement scales 21-1 and 21-2 extending in parallel on track 15 along the entirety of its length. Although not shown herein, main track 15 preferably includes at least one index or reference scale which can be used to initialize, or reset, the measurement, or counting, process engaged by encoder assembly 13.

As a feature of the present invention, second scale pitch SP₂ differs from first scale pitch SP₁. For example, first scale pitch SP₁ may be formed at 80 um, whereas second scale pitch SP₂ may be formed at 112 um. While the choice of each grating period can be arbitrary, satisfying the condition of m*SP1=n*SP2 provides signal processing efficiency and optimized memory resources utilization, where m and n are integers. The low spatial frequency error can be identified within the above-mentioned local processing block whose resultant information is saved over the entire main scale length for later processing. As will be explained further in detail below, encoder assembly 13 is designed to simultaneously compile two sets of encoder measurements, each using a unique scale pitch, in order to identify, and subsequently filter, interpolation error that may otherwise compromise encoder measurement accuracy.

In the present embodiment, system 11 is shown with main track 15 remaining fixed and encoder assembly 13 moving in relation thereto. However, it is to be understood that the principles of the present invention could be similarly applied with encoder assembly 13 remaining fixed and main track 15 moving along travel path P in relation to dual-encoder head 13. As a result, it is envisioned that the scope of the present invention readily encompasses both variations.

Additionally, in the present embodiment, system 11 is shown designed to measure movement along a travel path which is linear. However, it should be noted that the present invention is not limited to measuring movement along a linear travel path. Rather, it is to be understood that the principles of the present invention could be similarly implemented to measure movement along alternative travel paths, such as about a rotary path, without departing from the spirit of the present invention.

Furthermore, it is to be understood that a dual-pitch scale track could be alternatively formed by superimposing, or mixing, the pair of scale pitches on the same area and, in turn, recognizing each scale track using different sensing principles. For instance, each scale material could respond to a specific interrogating light source. Alternatively, scale tracks could be formed on the front and back sides of scale 15, instead of side-by-side on the same surface. Through this implementation, the so-called Abbe, or cosine, error can be minimized.

As will be explained in detail below, the unique dual-encoder design of encoder assembly 13 allows for the implementation of novel signal processing techniques to significantly reduce the presence of interpolation error and other non-periodic error measurements that are traditionally obtained using incremental encoders. Accordingly, both the unique design of encoder assembly 13 and the novel methods for reducing the presence of interpolation error from measurements serve as principal novel features of the present invention.

### Encoder Assembly 13

As noted briefly above, the unique dual-encoder head construction of assembly 13 allows for novel signal compensation techniques to be applied to its measurements in order to reduce interpolation error. As a result, system 11 is effectively designed to measure movement with great precision without requiring a commensurate increase in implementation costs, which is an object of the present invention. In other words, system 11 is configured to accurately measure movement using relatively inexpensive encoders (i.e., encoders which utilize a main grating having a relatively large period).

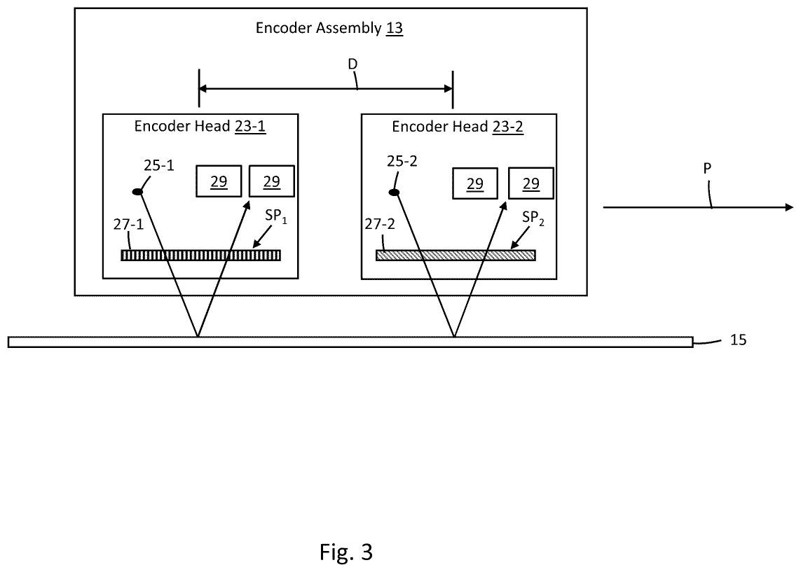

Referring now to FIG. 3, there is shown a simplified schematic representation of encoder assembly 13 relative to main track 15. As can be seen, encoder assembly 13 comprises (i) a first encoder head, or encoder, 23-1 which optically measures movement along travel path P, and (ii) a second encoder head, or encoder, 23-2 which optically measures movement along travel path P in an independent manner in relation to first encoder 23-1.

As seen most clearly in FIG. 2, first and second encoder heads 23-1 and 23-2 are offset laterally (i.e., orthogonally in relation to travel path P) such that first encoder 23-1 directly aligns above first measurement scale 21-1 and second encoder 23-2 directly aligns above second measurement scale 21-2. In this manner, each encoder head 23 is designed to independently compile a set of position measurements using a unique scale pitch.

Additionally, as seen most clearly in FIG. 3, second position encoder 23-1 is offset from first position encoder 23-1 a fixed or otherwise known (if dynamically changing) distance, or spacing, D along (i.e., in line with) the travel path P. As can be appreciated, applicant has uniquely identified that, by constructing encoder assembly 13 with two separate encoders 23, which are spaced a fixed, or otherwise known, distance apart, measurement data compiled from the pair of encoders 23 can be processed and analyzed to identify interpolation error, which is, in turn, subsequently filtered from position measurements in order to improve the overall accuracy of its measurements.

Each encoder head 23 is represented herein as a conventional incremental encoder which includes (i) a light source 25, such as a light-emitting diode (LED), (ii) an index grating, or mask, 27, with a scale pitch SP designed to be related to the scale pitch of its corresponding measurement scale 21, and (iii) a pair of photodetectors 29 maintained 90 degrees apart from one another in phase. In use, light generated from each light source 25 is transmitted through its corresponding index grating 27, is reflected off its respective scale 21 on main track 15 and is subsequently captured by its associated pair of photodetectors 29. Therefore, each incremental encoder 23 generates a pair of output signals A(t) and B(t), one from each photodetector 29, at various discrete points along measurement length L. Together, the pair of quadrature signals A₁(t) and B₁(t) and A₂(t) and B₂(t) are utilized to generate positions of phase θ₁(t) and θ₂(t) in the time domain within its associated measurement scale, which, in turn, is utilized to generate position measurements X₁(t) using the formula SP₁*θ₁(t)/2π and X₂(t) using the formula SP₂*θ₂(t)/2π.

As will be explained further below, the unique construction of encoder assembly 13 enables pairs of position measurements to be simultaneously captured by encoder heads 23-1 and 23-2, respectively, at discrete points in time along the entire length L of travel path P. In turn, the pairs of position measurements are processed and analyzed through a novel signal processing technique in order to identify and subsequently filter the presence of interpolation error.

As noted above, due to the effectiveness of the signal compensation process in reducing interpolation error, relatively inexpensive incremental encoders (i.e., encoders with a relatively large grating period) can be utilized in encoder assembly 13. As a result, it is to be understood that system 11 can be constructed and implemented with minimal cost, while maintaining a relatively high degree of measurement precision and accuracy.

It is envisioned that commercial, off-the-shelf, relatively inexpensive encoder heads be utilized for encoder heads 23-1 and 23-2. In turn, encoder heads 23-1 and 23-2 are preferably mounted on a printed circuit board to achieve the required separation D. For maximum measurement accuracy, the material utilized for the printed circuit board should be mechanically stable and have a low temperature coefficient of expansion.

### Method for Reducing Interpolation Error from Encoder Measurement Data

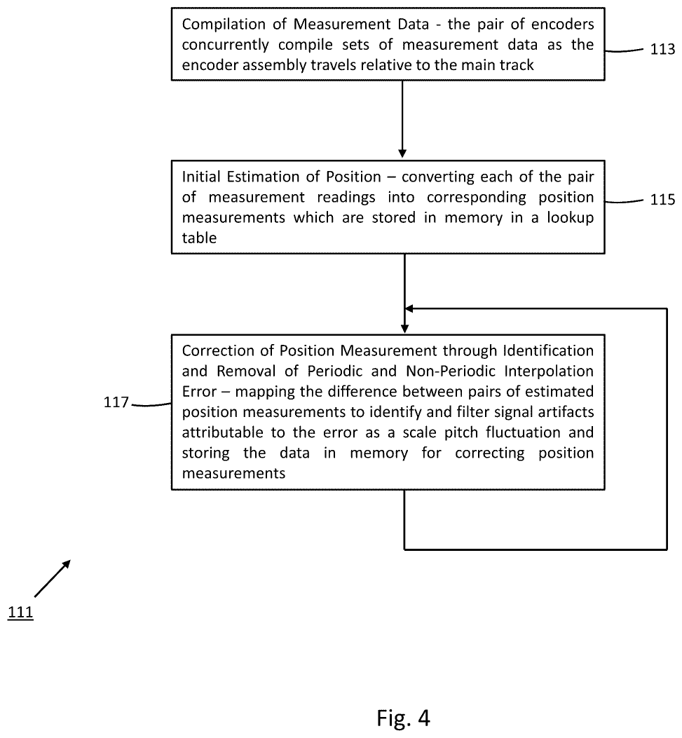

As referenced above, system 11 is uniquely designed to implement a novel technique for reducing interpolation and other types of encoder measurement errors that may otherwise compromise measurement accuracy. More specifically, in FIG. 4, there is shown a flow chart depicting a novel method for reducing interpolation error from measurement data compiled using the system 11 shown in FIG. 2, the method being implemented according to the teachings of the present invention and identified generally by reference numeral 111. As will be explained further in detail below, applicant has uniquely recognized that by maintaining encoder heads 23-1 and 23-2 a fixed or otherwise known distance apart, the output signals generated from encoders 23-1 and 23-2, when converted into the spatial domain, compared in relation to one another and mapped, produce certain visible signal artifacts, or characteristics, which are directly attributable to things (e.g., conditions) that cause interpolation error. Accordingly, these signal artifacts, once identified, can be removed, and thereby allow for the compensation, or correction, of measurement data in order to reduce the amount of residual interpolation error down to a level of a few nanometers. The method of the present invention is designed as an iterative correction process, with subsequent measurements utilized to further refine data correction and thereby optimize the resultant accuracy.

As can be seen, method 111 commences with a signal compilation step 113 in which encoders 23 collect pairs of measurement readings at various discrete points in time along the entirety of measurement length L as encoder assembly 13 travels relative to track 15. Each pair of measurement readings is generated by encoders 23-1 and 23-2 at the same moment in time (i.e., with encoder assembly 13 at the same position).

Each measurement reading generated by an encoder 23 produces a pair of time-based output signals A(t) and B(t), with each quadrature signal being generated by a corresponding photodetector 29. As will be explained further below, the collection of pairs of measurement readings from encoders 23, which are maintained a fixed distance apart, are utilized to identify certain types of interpolation error which may otherwise compromise measurement accuracy.

Thereafter, as part of position estimation step 115, each of the pair of measurement readings collected as quadrature signals A(t) and B(t) is converted by signal processing unit 17 into a first estimation of position X by calculating the arctangent of A(t)/B(t) as θ(t) while X(t)=SP*θ(t)/2π. X(t) often needs to be stitched over the one period of main scale pitch SP so that long distance position can be properly measured.

As will be explained further in detail below, position estimation step 115 preferably engages in a preconditioning, or pre-calibration, process to initially remove certain forms of interpolation error from each of quadrature signals A(t) and B(t) that are commonly attributable to non-perfect sine waves, unequal signal amplitudes, and non-zero offsets. Subsequent processing steps in method 111 are, in turn, designed to identify and filter other types of interpolation error that are commonly attributable to internal factors, such as encoder manufacturing imperfections and scale periodicity error.

As will be explained in detail below, the difference between each pair of position measurements X₂−X₁ should remain a constant value, since encoder heads 23-1 and 23-2 are maintained a fixed distance D apart. However, in actuality, applicant has uniquely recognized that interpolation error creates variations in the measured difference between pairs of position measurements X₂−X₁, which when mapped as a function of X₁ or X₂ in the spatial domain, produce readily identifiable signal artifacts. Through signal processing as part of step 117, these artifacts can be eliminated, or significantly reduced, in order to improve the overall precision of each position measurement.

As a feature of the invention, the identification and reduction of interpolation error performed in step 117 can be accomplished even if each of position measurements X₁ and X₂ includes a significant amount of periodic interpolation error (i.e., without performing preconditioning step 115). This is because step 117 relies upon the mutual distance, or difference, between the pair of measurements. When the scale pitch SP1 is different from the scale pitch SP2, the spatial frequencies of the periodic error in SP1 will be different from those of SP2, and the difference between X₁ and X₂ will contain both spatial frequencies, which can be identified and subtracted from the position measurements.

With compensated position measurements stored in memory 19, it is to be understood that step 117 is designed to be an iterative correction process. In other words, step 117 is preferably repeated using updated, or corrected, position measurements to further refine the collected data in real time and thereby optimize the resultant accuracy.

### Initial Position Estimation Step 115

As referenced briefly in FIG. 4, initial position estimation step 115 preferably engages in a preconditioning, or pre-calibration, process to remove interpolation error that occurs over one grating period from each set of quadrature signals A(t) and B(t) from each of encoder head 23. While subsequent step 117 can be accomplished regardless of whether each set of quadrature signals A(t) and B(t) is pre-calibrated, starting from more accurate position estimation in this way would be advantageous to reach the correct position measurement more efficiently.

Specifically, as referenced above, the quadrature outputs from a position encoder can be ideally represented using the following formulas:

$$A ( t ) = C ( t ) * sin ( θ ( t ) ) + Va ( t ) \qquad ( 1 )$$

$$B ( t ) = D ( t ) * cos ( θ ( t ) + α ) + Vb ( t ) = D ( t ) * \{ cos ( θ ( t ) ) * cos ( α ) - sin ( θ ( t ) ) * sin ( α ) \} + Vb ( t ) ∼ D ( t ) * \{ cos ( θ ( t ) ) - sin ( θ ( t ) ) * α \} + Vb ( t ) ) \qquad ( 2 )$$

wherein each of Va(t) and Vb(t) is the bias signal contained in its respective quadrature output, C(t) and D(t) represent the amplitudes of each quadrature signal, and a is the relative error in phase deviation from 90 degrees between the quadrature outputs, A(t) and B(t). Ideally, phase deviation error α and bias signals Va(t) and Vb(t) should be zero, and amplitudes C(t) and D(t) should be the same value. Therefore, using equation (1) and equation (2), position or phase θ(t) within the main scale period can be determined by simply calculating the arctangent of (A(t)/B(t)). However, it has been found that actual quadrature signals A(t) and B(t) produced by an encoder include either (i) non-zero phase deviation error α, (ii) non-zero bias signals Va(t) and Vb(t), and/or (iii) unequal amplitudes C(t) and D(t).

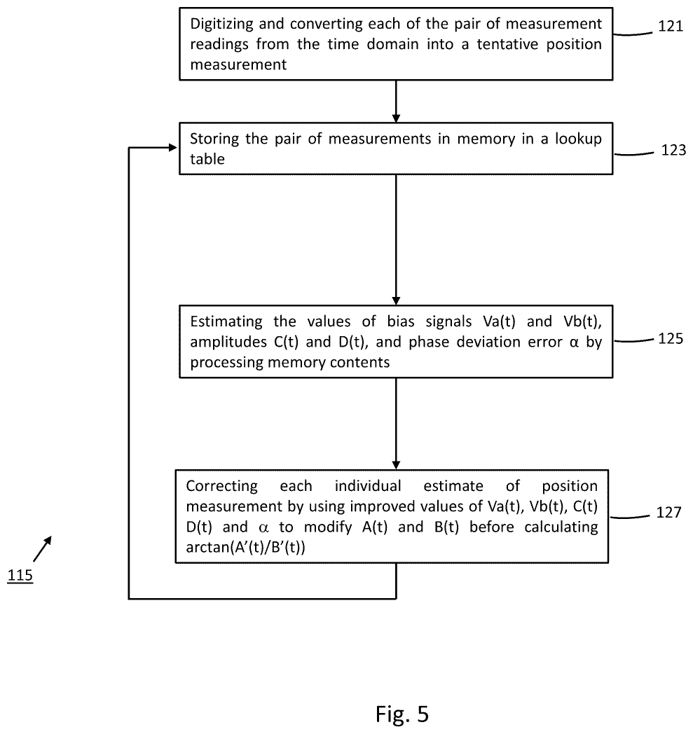

Accordingly, in FIG. 5, there is shown a flow chart for initial position estimation step 115 which details the process in which quadrature signals A(t) and B(t) are preferably preconditioned in order to initially remove interpolation error that occurs over one period of the scale grating of each encoder from the measurement data. As can be seen, in step 121 in the preconditioning process, each pair of measurement readings, collected as quadrature signals A(t) and B(t), is converted by signal processing unit 17 from the time domain into the spatial domain as a function of position A(θₑₛₜ), B(θₑₛₜ) relative to its associated scale 21. Accordingly, signal processing unit 17 is able to determine a position or phase estimate θₑₛₜ(t) by calculating the arctangent of position functions, namely, θₑₛₜ=arctan(A(t)/B(t)), where θₑₛₜ is stitched beyond one scale period SP in practice, as is commonly known in the art. In turn, the position or phase estimate θₑₛₜ(t) is utilized to generate a position measurement X using the formula SP*θₑₛₜ(t)/2π.

As part of initializing step 123, two maps are created in memory 19 by signal processing unit 17. The contents of one map contains an A value, and the contents of the other map contains a B value. The values are stored at memory locations corresponding to the first position estimation Θ, resulting from taking the arctan(A/B). Once the memory mapping process has been completed over a one or multiple scale periods as a result of movement, it should be noted that each of bias signals Va(t) and Vb(t), amplitudes C(t) and D(t), and phase deviation error a can be estimated using the equations (3)-(7) set forth below, where m & n are integers and m≠n.

$${\hat{V}}_{a} ( t ) = \frac{1}{m + n} {\int }_{- n 2 π}^{m 2 π} A ( \hat{θ} ) d θ \qquad ( 3 )$$

$${\hat{V}}_{b} ( t ) = \frac{1}{m + n} {\int }_{- n 2 π}^{m 2 π} B ( \hat{θ} ) d θ \qquad ( 4 )$$

$$\hat{C} ( t ) = \frac{2}{m + n} {\int }_{- n 2 π}^{m 2 π} A ( \hat{θ} ) * sin ( \hat{θ} ) d θ \qquad ( 5 )$$

$$\hat{D} ( i ) = \frac{2}{m + n} {\int }_{- n 2 π}^{m 2 π} B ( \hat{θ} ) * cos ( \hat{θ} ) d {θ}^{x} \qquad ( 6 )$$

$$\hat{α} = - \frac{1}{\hat{D}} \frac{2}{m + n} {\int }_{- n 2 π}^{m 2 π} B ( \hat{θ} ) * sin ( \hat{θ} ) d θ \qquad ( 7 )$$

where \hat{θ}=θₑₛₜ is calculated from original A(t), B(t).

Finally, using these estimated values, amplitudes C(t) and D(t) are preferably balanced as part of measurement step 127. Additionally, in step 127, phase deviation a and bias signals Va(t) and Vb(t) are cancelled. As a result, original quadrature signals A(t) and B(t) are effectively compensated as first-order corrected signals A′(t) and B′(t), which result in producing a new position estimation by calculating arctan (A′(t)/B′(t)) as Θ(t) where position x(t)=SP*θ(t)/2π. This is a recursive process, and the contents of the maps are always being updated, both due to iterations around the loop and due to movement detected by each encoder. In this manner, interpolation error that occurs within one grating pitch of each encoder is effectively removed from the position measurement data.

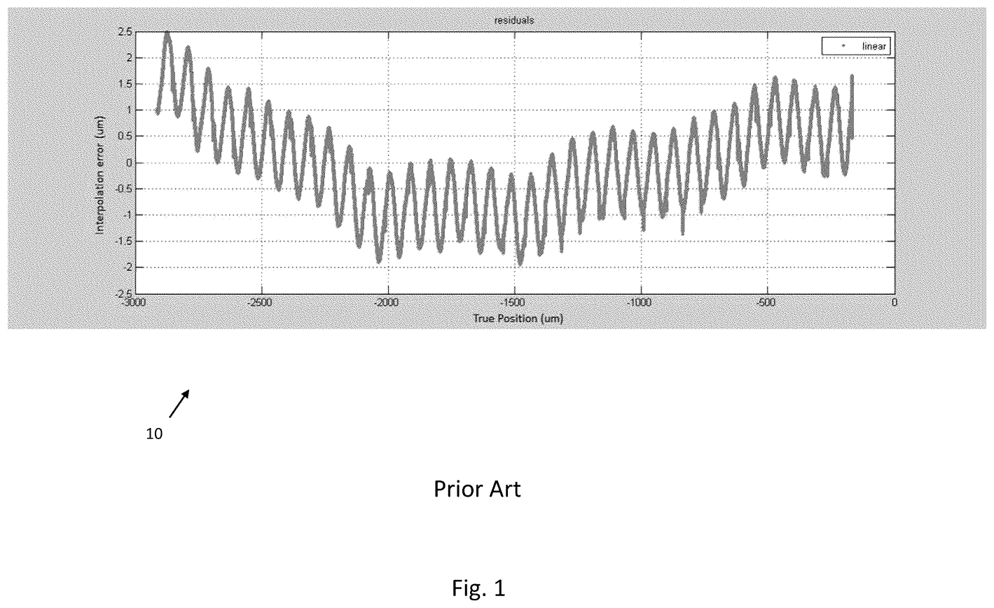

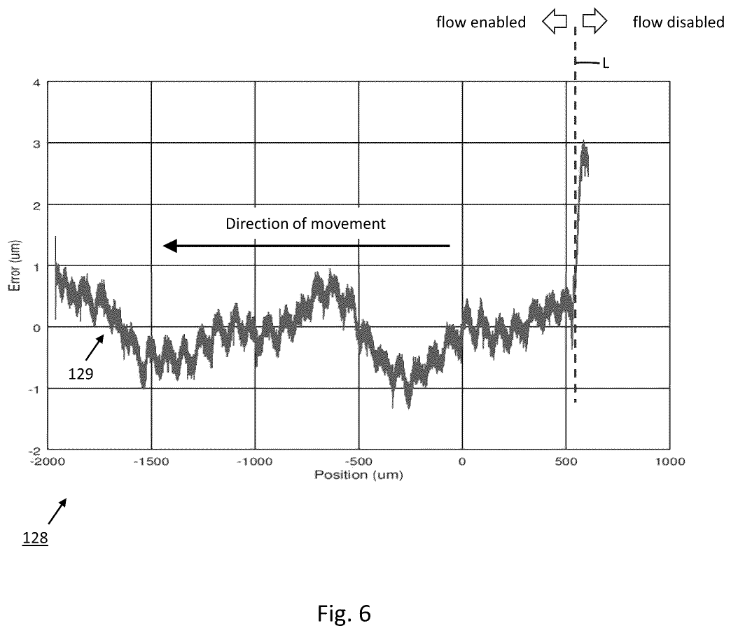

In FIG. 6, a graph 128 is shown which depicts the actual reduction in measured periodic interpolation error achieved as a result of initial position estimation step 115, with signal processing flow executed using a field programmable gate array (FPGA) for a real-time position estimation. In graph 129, flow enabled movement commences from line L and travels from right to left. Initially, the interpolation error before any compensation is enabled (i.e., right of line L) is ˜3 μm, which is similar to the interpolation error measurements compiled in prior art FIG. 1. However, as the stage starts moving (i.e., left of line L), the interpolation error drops to ˜300 nm peak to peak. This represents a 10× improvement.

### Interpolation Error Identification and Reduction Step 117

As referenced above, signal processing unit 17 engages in a novel interpolation identification and elimination step 117 in order to improve the accuracy of position measurements compiled by encoder heads 23-1 and 23-2.

As will be explained in detail below, dual-head encoder 13 is uniquely designed to simultaneously compile two sets of position measurements, each from a corresponding encoder head 23 that utilizes a unique scale pitch. Because encoders 23-1 and 23-2 are maintained a fixed or known distance D apart, the difference, or mutual distance, between each pair of position measurements should remain constant or known (e.g., distance D), regardless of the position of encoder assembly 13 relative to track 15. However, in actuality, applicant has recognized that the mutual distance between each pair of position measurements tends to fluctuate throughout the travel path P.

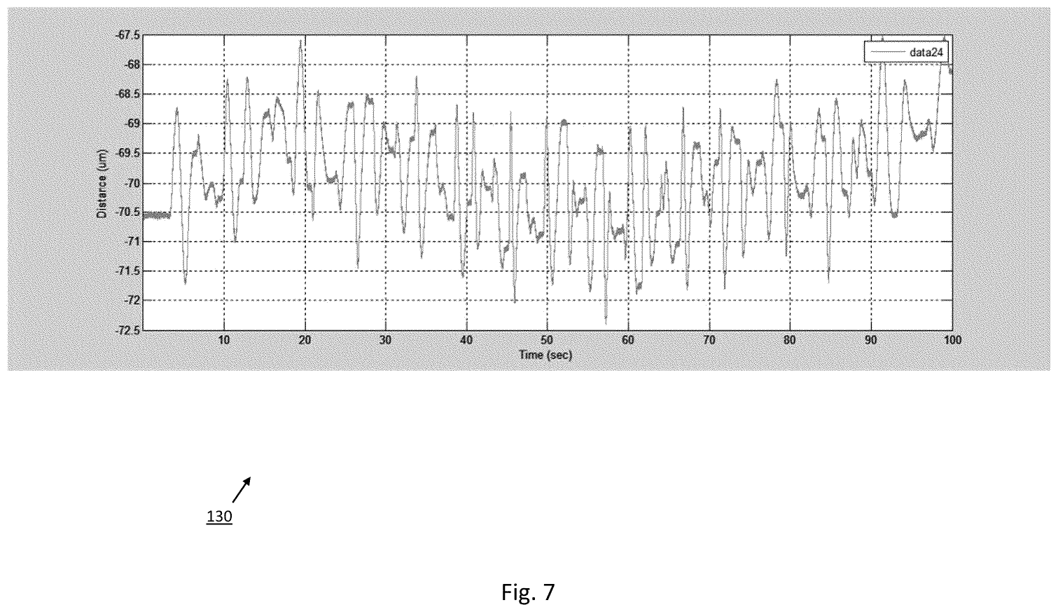

For example, in FIG. 7, there is shown a graph 130 which depicts actual test data of the mutual distance between a pair of fixed encoder heads measured throughout a designated travel path. As can be seen, the measured mutual distance tends to fluctuate through the entire travel path.

By processing, comparing, and mapping the mutual distance data, this interpolation error can be readily identified and subsequently treated, thereby resulting in compensated position measurements with minimal error. Details of interpolation error identification and reduction step 117 are set forth in detail herein.

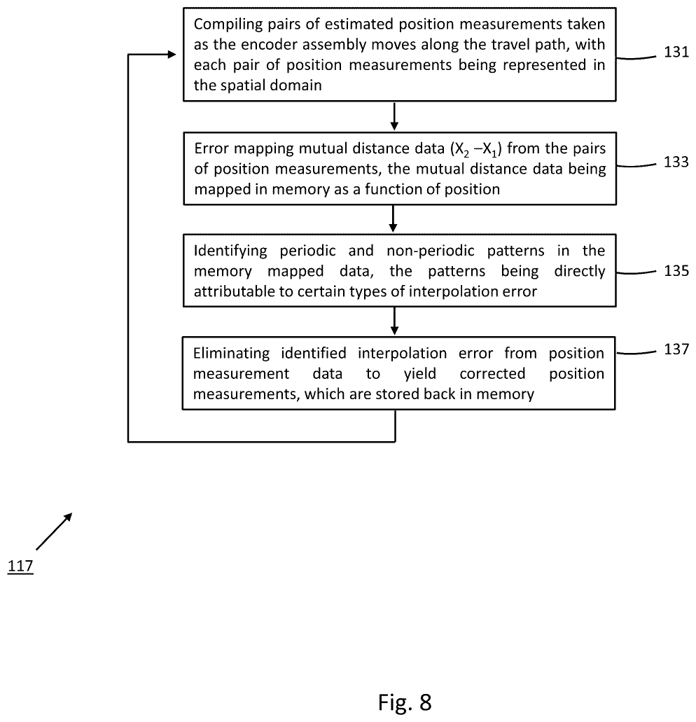

Specifically, in FIG. 8, there is shown a flow chart depicting the details of interpolation error identification and elimination step 117. As an initial step 131, signal processing unit 17 compiles pairs of position measurements X1, X2 from memory 19 which were previously converted into the spatial domain and preconditioned as part of step 115. As noted above, the pairs of position measurements X1, X2 are collected as encoder assembly 13 travels along path P, with each encoder head 23 responsible for capturing one of the pair of position measurements X1, X2 at the same moment in time.

Thereafter, as part of an error mapping step 133, mutual distance information (X2−X1) from the pairs of position measurements X1, X2 is mapped in memory 19 as a function of either position measurements X1 or X2.

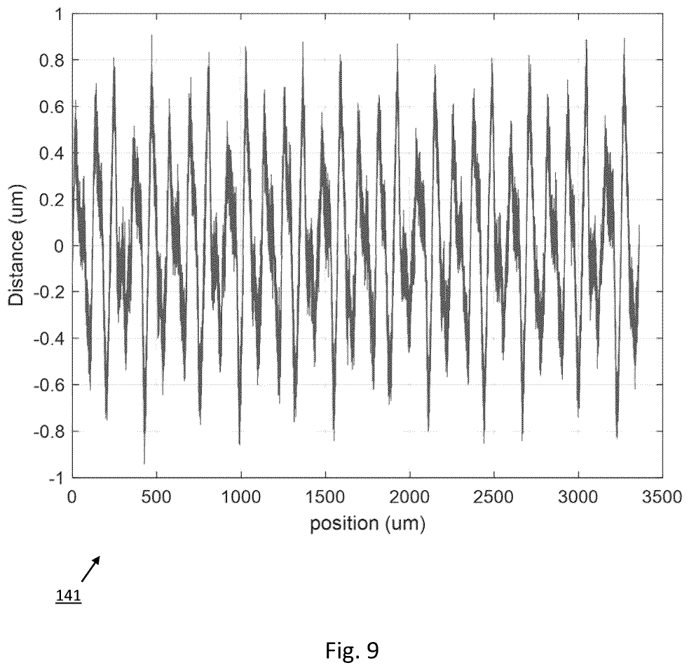

In FIG. 9, there is shown a graph 141 which depicts actual memory-mapped contents after subtracting a low spatial frequency error (i.e., through a high pass spatial filtering). It should be noted that the mutual distance data utilized in graph 141 is based on the same data as shown in graph 130 in FIG. 7. As can be seen, the application of the aforementioned filtering step significantly reduces the measured fluctuation in mutual distance.

Referring back to FIG. 8, once error mapping is completed, periodic and non-periodic patterns in the memory mapped data are identified as part of an interpolation error detection step 135. The time domain plot of (X2−X1) shown in FIG. 7 appears to be random, whereas the same differences plotted in the spatial domain and shown in FIG. 9 identify periodic errors that can be removed.

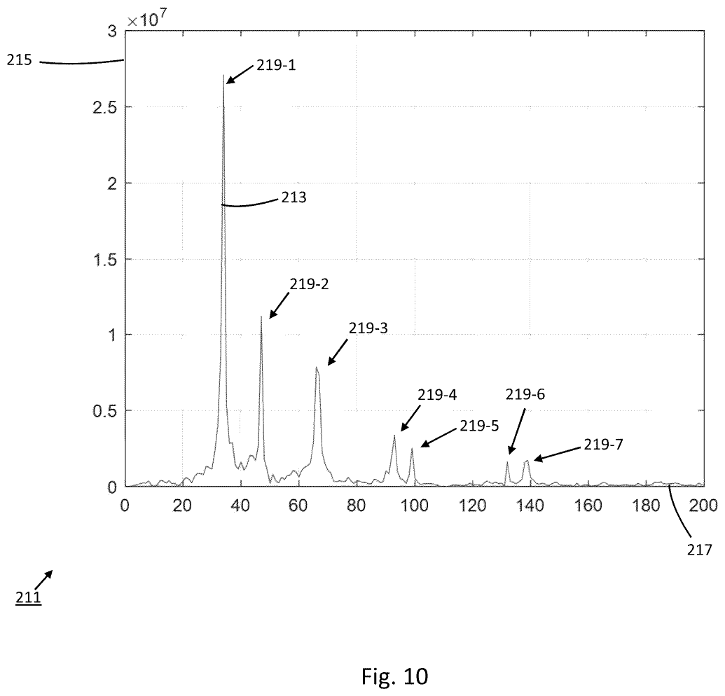

One useful method to help identify periodic patterns in the memory mapped data is to perform either a fast Fourier transform (FFT) or a discrete Fourier transform (DFT) on the mapped data. In FIG. 10, an example of a FFT data plot is shown, the plot being represented generally by reference numeral 211. In plot 211, a fast Fourier transform 213 of the mapped data is represented along vertical axis 215 in terms of amplitude and along horizontal axis 217 in terms of frequency (Hz). As can be seen, FFT 213 displays multiple spatial frequency peaks 219-1 thru 219-7. As a feature of the invention, it has been recognized that frequency peaks 219 are directly attributable to certain types of interpolation error created due to scale periodicity inaccuracies.

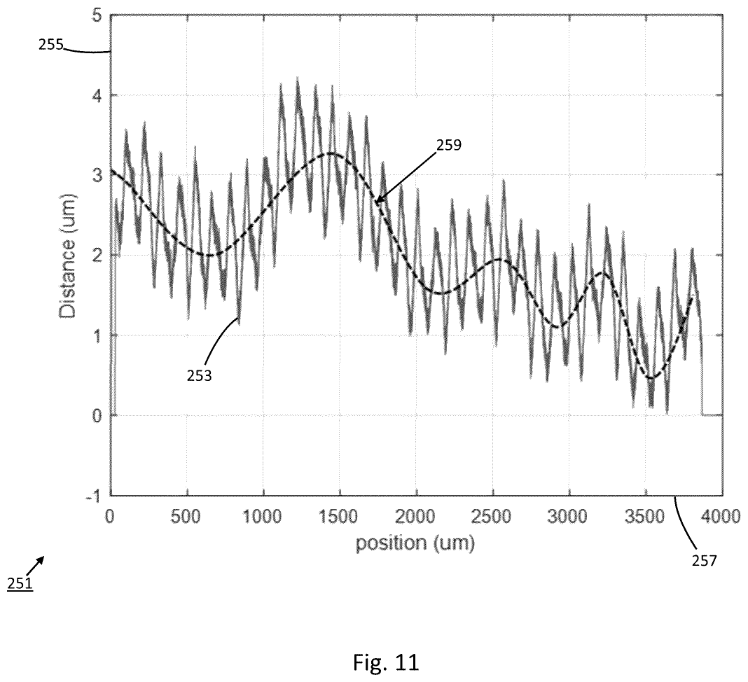

Although useful in identifying certain forms of interpolation error, detection step 135 does not necessarily require a Fourier transform in order to identify interpolation error. For example, in FIG. 11, an example of a mapped data plot is shown, the plot being represented generally by reference numeral 251. In plot 251, position measurement data 253 is represented along vertical axis 255 as the mutual distance, or difference, (X2−X1) between pairs of position measurements X1, X2 and along horizontal axis 257 as a function of one set of position measurements (e.g., X1). As evidenced by dashed trend line 259, position measurement data 253 exhibits non-linear fluctuations due to low-spatial frequency error in the scale periodicity of track scales 21.

Referring back to FIG. 8, once interpolation error is identified in detection step 135, a correction step 137 is implemented to remove system-related interpolation error from the position measurement data. For instance, using data plot 211 in FIG. 10, identified frequency peaks 219 are preferably eliminated from original position measurements. As a result, corrected, or adjusted, position measurements are generated which, in turn, are stored in memory 19. In this manner, interpolation error is effectively removed from the position measurement data stored in memory 19.

As previously mentioned, step 117 is designed to be a recursive and iterative correction process. As a result, step 117 is preferably repeated using updated, or corrected, position measurements stored in memory to further refine the collected data in real time and thereby optimize the resultant accuracy.

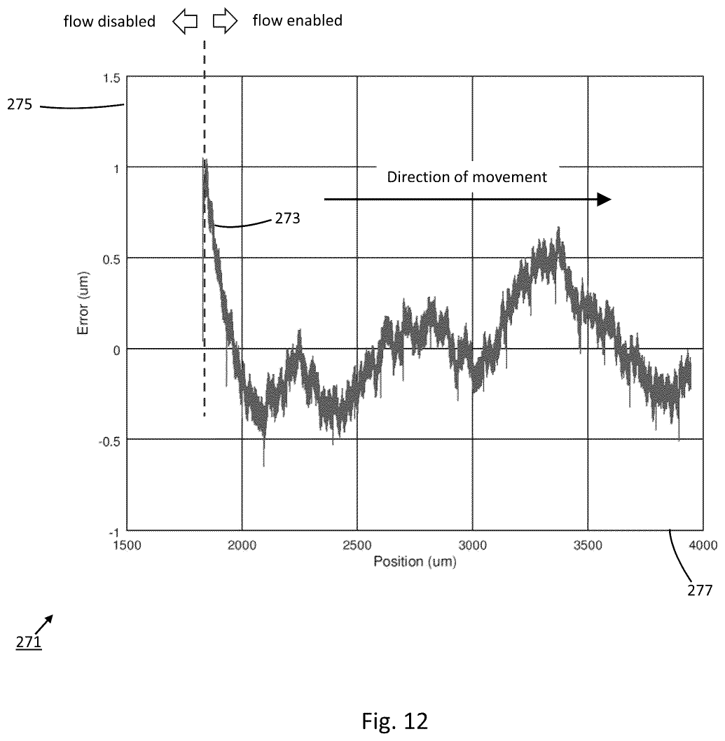

In FIG. 12, actual test results obtained through the implementation of system 11 are represented as data graph 271. In graph 271, test data 273 is shown along vertical axis 275 in terms of the residual interpolation error and along horizontal axis 277 in terms of true position, as measured by a high-performance position encoder. As can be seen, method 111 is responsible for reducing the amount of interpolation error in position measurements obtained from system 11 to approximately 80 nm. This measured reduction in periodic interpolation error is approximately 20-40 times greater than position measurements obtained using a single incremental encoder of similar quality.

### Alternative Constructions and Design Modifications

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

While having multiple position encoder units with different pitch scales would be ideal to minimize interpolation and other sources of error as disclosed earlier, a similar concept can be applied to a single encoder unit with a single scale under a specific design configuration. This comes with considerable cost savings, but with a compromise in performance improvement.

In the case of conventional sine/cosine position encoders, detectors inside the head can be regarded as two or multiple independent position encoder units under a certain circumstance or a design configuration. In the configuration described below, multiple position encoder units within one encoder head looking at a single scale with a single grating is further used to eliminate interpolation and scale periodicity error.

Assuming that the local interpolation error characteristics of the encoder heads are identical with two detectors, the estimated position from each encoder position x1 and x2 would be expressed as:

$$x 1 = x 0 + Σ Ei * sin ( i * x 1 / P 1 * 2 * pi + ai ) \qquad ( 11 )$$

$$x 2 = x 0 + Σ Ei * sin ( i * x 2 / P 1 * 2 * pi + a i ) + delta \qquad ( 12 )$$

where “P1” is the grating scale period, “Ei” is amplitude related to interpolation error of ith order, “ai” is a spatial phase of the cyclic interpolation error, “delta” is the known distance between the two encoder units, and “x0” is the true position. Taking the difference of the estimated positions from two encoder units, one gets:

$$x 2 - x 1 = Σ Ei * sin ( i * x 2 / P 1 * 2 * pi + a i ) - Σ Ei * sin ( i * x 1 / P 1 * 2 * pi + a i ) + delta \qquad ( 13 )$$

Recall that sin x−sin y=2 cos {(x+y)/2}sin {(x−y)/2}. For simplicity of description, the ith spatial frequency of the interpolation error can be described as:

$$Ei * sin ( i * x 2 / P 1 * 2 * pi + a i ) - Ei * sin ( i * x 1 / P 1 * 2 * pi + ai ) = 2 Ei * cos ( i ( x 1 + x 2 ) / P 1 * pi + ai ) * sin ( i * delta / P 1 * pi ) \qquad ( 14 )$$

The goal, in this case, is to estimate “Ei” and “ai” at the ith order accurately, keeping in mind that “delta” is a constant value. The memory-mapping-based signal processing method as disclosed earlier can then be applied in order to estimate these values not only for the first order interpolation error term but also for high order terms contained in Equation 13 as well.

Unfortunately, if the value of “delta” happens to be exact integer multiples of the scale period (i.e. delta=x2−x1=m*P1) where m is an integer number, the interpolation error term contained in Equation (14) becomes zero since sin(i(x2−x1)/P1*pi)=sin(i*m*pi)=0, thus it becomes impossible to estimate “Ei” and “ai” despite its existence. These limitations will be mitigated by a few methods described later.

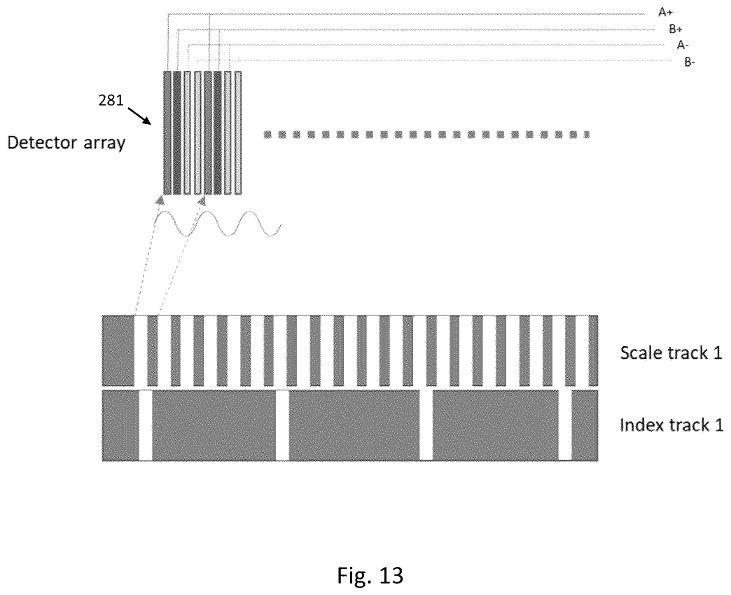

As mentioned earlier, the photodetector outputs of an encoder head, A and B, are typically provided as differential signals. Especially when an encoder is implemented as an IC, the differential outputs may be the result of an array of individual photodetectors spaced apart by one quarter of the grating pitch, as depicted by detector array 281 in FIG. 13. The single ended outputs of these photodetectors can be used as separate input signals to interpolation error reduction processing blocks. A+, B+, A−, B− are denoted as outputs corresponding from detector array 281 and can be represented as follows:

$$A + ( t ) = V a + C ( t ) * sin ( x / p * 2 * pi ) \qquad ( 17 )$$

$$B + ( t ) = V b + D ( t ) * cos ( x / p * 2 * pi ) = V b + D ( t ) * sin ( x / p * 2 * pi + pi / 2 ) \qquad ( 18 )$$

$$A - ( t ) = V a - C ( t ) * sin ( x / p * 2 * pi ) = V a + C ( t ) * sin ( x / p * 2 * pi + pi ) \qquad ( 19 )$$

$$B - ( t ) = V b - D ( t ) * cos ( x / p * 2 * pi ) = V b + D ( t ) * sin ( x / p * 2 * pi + 3 * pi / 2 ) \qquad ( 20 )$$

Assuming that C(t)=D(t) and Va=Vb, the above equation shows that each output is pi/2 spatially phase-shifted in relation to each other output. There are a few potential combinations for these single-ended outputs to form the signals to be used as the two inputs to the interpolation reduction block. Here are three examples with simplistic descriptions in order to form an individual position encoder pair.

Pair 1−Encoder unit 1: group of A+, B+, Encoder unit 2: group of A−, B−, with mutual unit distance P1/2

Pair 2—Encoder unit 1: group of A+, B+, Encoder unit 3: group of B+, A−, with mutual unit distance P1/4

Pair 3—Encoder unit 1: group of A+, B+, Encoder unit 3: group of B−, A+, with mutual unit distance 3*P1/4

For pair 1 above, the distance between the virtual encoder unit 1 and unit 2 would be P1/2. This is when the output of Equation 14 becomes maximum when i=1, 3, 5, . . . , thus the interpolation error term E1, E3, E5, . . . and a1, a3, a5 . . . can be estimated according to the disclosed method in this patent. Similarly, for case 2, the measured distance between the Encoder unit 1 and 2 would be P1/4. The output of Equation 14 becomes maximum when i=2, 6, 10 . . . , thus interpolation error term E2, E6, E10 . . . and a2, a6, a10 . . . can be estimated accordingly.

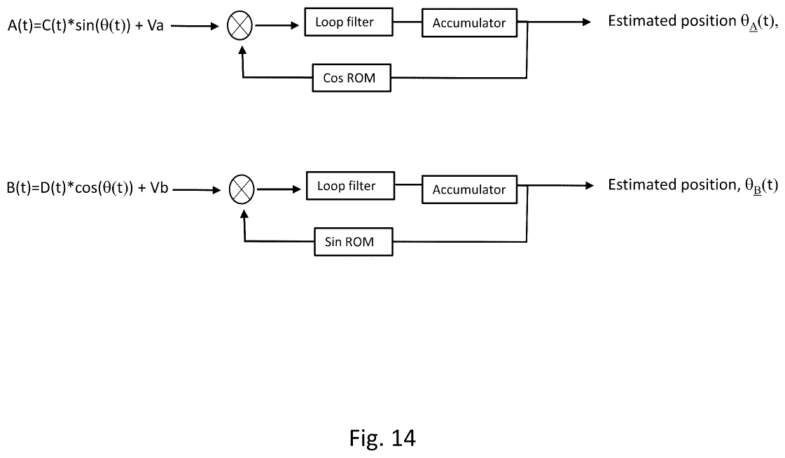

FIG. 14 illustrates an alternative means to effectively obtain two position encoder units from a conventional single position encoder head reading a single scale. This variation is particularly useful when interpolation at high speed, such as when tracking a rotating object, is required. At a high-speed of motion, the position encoder output is naturally frequency/phase-modulated. This effectively creates two detector units, which are tracking the same positions simultaneously with a mutual distance of P1/4.

$$A = C * sin ( x 1 ( t ) / P 1 * 2 * pi ) + Va \qquad ( 21 )$$

$$B = D * sin ( x 2 ( t ) / P 1 * 2 * pi + a ) + Vb \sim D * sin ( x 2 ( t ) / P 1 * 2 * pi ) - D * a * cos ( x 2 ( t ) / P 1 * 2 * pi ) + Vb \qquad ( 22 )$$

When d(x1)/dt becomes fast enough, the position can be decoded from the single quadrature signal output alone without any effect of bias nor amplitude imbalance of the incoming signals.

As can be seen, the estimated position can be derived first by multiplying X_sin(Θ) by cos(Θ), which acts like a phase detector, followed by a loop filter and an accumulator. A synthesized quadrature signal is then generated from the estimated position, which repeats until the phase detector output becomes zero. The same can be applied to the X_cos(Θ) signal. Once each corresponding position is derived, the same interpolation reduction method described in Equation 14 can be applied for further reduction of the interpolation error.

In general, the issue associated with a discrete “delta” mentioned above can be mitigated by shifting the distance between the two detector positions or fringe pattern positions dynamically so that the value of sin (i*delta/P1*pi) can become maximized or at least a non-zero value. Such operation can be done in multiple ways, for example, changing the mutual distance of detector units with a piezo, thermal, magnetic, electro-static actuator, or other physical actuator means.

The principles of the present invention could also be applied to a novel microsensor. Sometimes, there are applications which require a position measurement right at the end-effector location. In these applications, deploying a physical reference grating for the purpose of motion sensing may not be practical. A micro-electromechanical system (MEMS) gyroscope sensor using vibrating mass as part of detection element could be one example where a vibrating element is so small that the space and mass of a conventional scale and grating to measure its motion cannot be used. In robotics applications, tracking 3D positions for the end-effector, such as gripper, at nanometer accuracy is highly challenging with conventional linear/rotary position encoders. Although the size of the desired encoder is small, it is possible to obtain two output signals and use the methods disclosed herein to provide position measurements with extremely low measurement error due to greatly reduced interpolation error of all kinds.

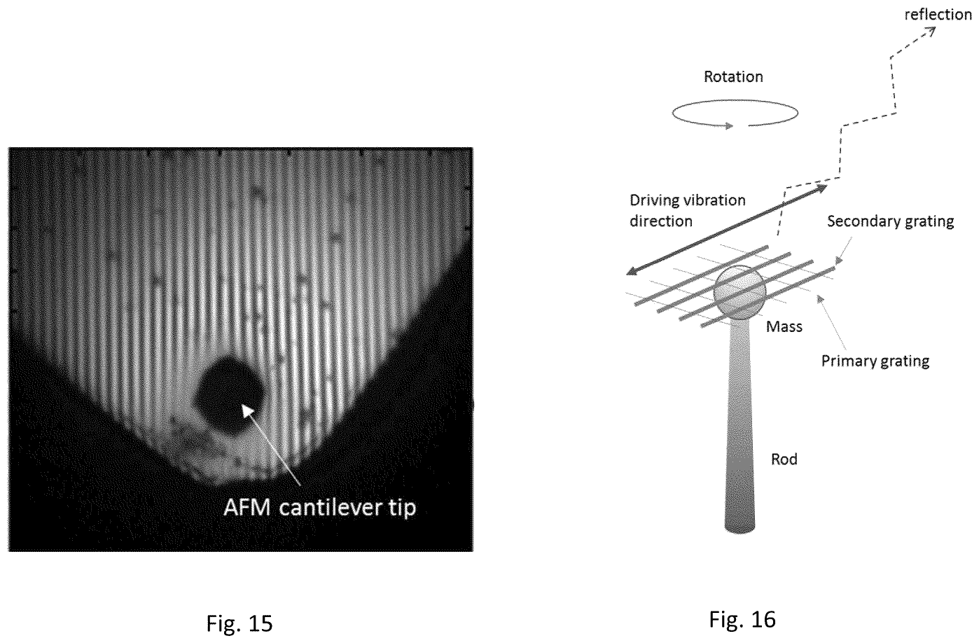

FIG. 15 depicts a way of solving the problem of requiring a scale of ultra-low size and mass. In this case, a fringe pattern is projected onto the target dot mass/particle/end-effector, and an encoder head detects a changing signal as the target moves and/or as the projected fringe pattern is spatially oscillated. Such a projection method enables one to use any combination of spatial and chromatic grating patterns with different spatial frequencies, simultaneously and/or through time-multiplexing for fringe orientation and/or combination with the conventional physical grating for unique results.

The use of conventional sine/cosine encoders in this application is able to detect motion and remove interpolation error, but it cannot detect the direction of the motion unless projecting 90° spatial phase shifted fringe pattern at the same time or alternatively. Using the type of position encoders disclosed in U.S. Pat. No. 5,589,686 allows high accuracy detection of both position and direction and requires that the projected pattern oscillate in the direction of motion to be measured.

Similarly, in the case of a MEMS gyro sensor which is based on Coriolis force applied to a vibrating mass object or particle, it is critical to be able to measure the displacement of the target mass both in the driving and the sensing direction accurately for stable and precise measurement. In FIG. 16, there is shown a preferred embodiment in which principles disclosed herein are applied to a MEMS gyro sensor. Acceleration, force and other types of sensors can benefit from the same concept. Specifically for the gyro sensor, the projection method uses a combination of spatial and chromatic grating patterns with different spatial frequencies, simultaneously and/or through time-multiplexing for orthogonal fringe orientation and/or combination with the conventional physical grating for unique results taking advantages disclosed herein.

A small mass in this case, can be comprised of high reflectance coating, quantum dots, fluorescent particles, and the like, which are supported on a light-absorbing or transparent material whose entire structure is vibrated under a forced vibration or at its resonance frequency. Such material could be a nano carbon tube, MEMS, NEMS, glass or the like to enable a low cost and high frequency operation, resulting in high bandwidth position sensing. The reflection from the mass alternates as it goes through projected fringe dark and bright lines due to the vibration. By detecting the intensity of the reflected light synchronous to the vibration, one can measure the position of such mass/particle very accurately in the driving vibration direction.

It is to be understood that the present invention could apply equally for these sensors by having multiple of the sensing elements corresponding with a different spatial frequency of the projected fringes, detecting the position in the same orientation.

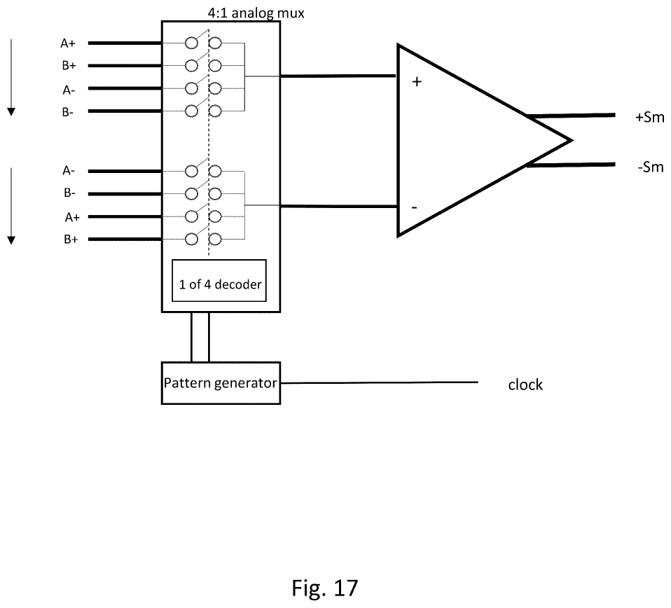

A potential issue when multiple outputs are being analyzed is that number of the wires required to transmit the position encoder information from the sensor head to the signal processing unit might increase complexity and as a result, increase the overall cost and/or decrease reliability. This issue can be mitigated by utilizing an innovative time-multiplexing method, with FIG. 17 depicting one of several possible implementations.

As seen in FIG. 17, a simple analog multiplexer could be used instead of an expensive analog multiplier in order to achieve pseudo phase modulation. This is equivalent to scanning the scale surface from 0 to 2*pi phase sequentially with pi/2 discrete steps as described in Equation (17).

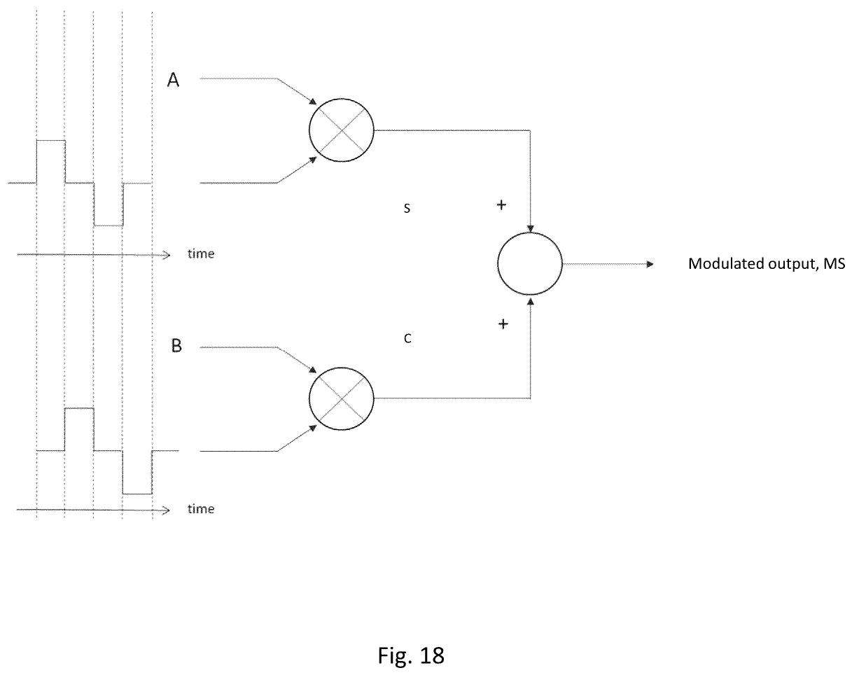

The operation of the analog multiplexer in FIG. 17 can be explained using the model shown in FIG. 18 which uses analog multiplexers. Note that switching action is equivalent of multiplying the output by 1 or −1 due to differential settings. A and B signals from a position encoder module is converted into a single output MS as:

$$MS = S + C = E 1 * sin ( wrt + x / p * 2 * pi ) + E 3 * sin ( 3 * wrt + x / p * 2 * pi ) + E 5 * sin ( 5 * wrt + x / p * 2 * pi ) + … \qquad ( 23 )$$

where p is a scale period, x is the position, wr>>dx/dt/p*2*pi, A=sin(x/p*2*pi) and B=cos(x/p*2*pi) are assumed. E1, E3, E5 . . . are constants defined by the Fourier transform of the square waveform used for the modulation. A and B signals can be digital (binary) square waves as is typically used for digital output position encoders, although the achievable position measurement resolution would be reduced accordingly.

This enables the main signal bandwidth region to be shifted to a higher-frequency region, which is far from 50˜120 Hz power line noise, for example. Once this configuration is implemented before being transferred over a cable to the receiver end, not only it will reduce the number of transmission wires, but also it will reduce the noise coupling whose frequency is in the low frequency range. The new configuration implementation can be equally applied for a different switching timing instead of simple sequential one as illustrated in FIG. 17. Changing the switching sequence as well as the pulse width would enable more sophisticated phase modulation, resulting in better signal-to-noise position data transmission with low interpolation error.

What is claimed is:

1. A system for measuring movement along a travel path, the system comprising:
(a) an encoder assembly positioned relative to a main track, one of the encoder assembly and the main track being configured to move relative to the other along the travel path, the encoder assembly comprising,
(i) a first encoder configured to generate position measurements relative to the main track, and
(ii) a second encoder offset from the first encoder a fixed distance relative to the travel path, the second encoder being configured to generate position measurements relative to the main track,
(iii) wherein the first and second encoders concurrently generate pairs of position measurements in the time domain based on the position of the encoder assembly relative to the main track; and
(b) a signal processing unit in electrical communication with the encoder assembly;
(c) wherein the signal processing unit converts the pairs of position measurements in the time domain into corresponding position measurements in the spatial domain, the signal processing unit creating a map of the difference between each pair of position measurements in the spatial domain throughout the travel path, the map including periodic patterns which are directly attributable to interpolation error.

2. The system as claimed in claim 1 wherein the signal processing unit identifies periodic patterns in the map of the difference between each pair of position measurements in the spatial domain.

3. The system as claimed in claim 2 wherein the signal processing unit minimizes the presence of periodic patterns in the map in order to reduce interpolation error and thereby correct the pairs of position measurements in the spatial domain.

4. The system as claimed in claim 3 wherein the signal processing unit identifies and minimizes the presence of periodic patterns in the map through a recursive process.

5. The system as claimed in claim 3 wherein the difference between each pair of position measurements in the spatial domain is mapped as data relative to one of the pair of position measurements.

6. The system as claimed in claim 3 wherein the signal processing unit identifies periodic patterns in the map of the difference between each pair of position measurements in the spatial domain by performing at least one of a fast Fourier transform and a discrete Fourier transform on the mapped data to yield spatial frequency peaks at select frequencies.

7. The system as claimed in claim 6 wherein the signal processing unit filters out mapped data at the select frequencies with spatial frequency peaks.

8. The system as claimed in claim 3 wherein the first encoder is configured to generate position measurements relative to the main track using a first scale pitch.

9. The system as claimed in claim 8 wherein the second encoder is configured to generate position measurements relative to the main track using a second scale pitch.

10. The system as claimed in claim 9 wherein the second encoder is configured to generate position measurements relative to the main track using a second scale pitch which differs from the first scale pitch.

11. A system for measuring movement along a travel path, the system comprising:
(a) an encoder assembly positioned relative to a main track, one of the encoder assembly and the main track being configured to move relative to the other along the travel path, the encoder assembly concurrently generating pairs of position measurements in the time domain based on the position of the encoder assembly relative to the main track, each pair of position measurements including first and second measurements set at a fixed distance apart from one another relative to the travel path; and
(b) a signal processing unit in electrical communication with the encoder assembly;
(c) wherein the signal processing unit converts the pairs of position measurements in the time domain into corresponding position measurements in the spatial domain, the signal processing unit creating a map of the difference between each pair of position measurements in the spatial domain throughout the travel path, the map including periodic patterns which are directly attributable to interpolation error.

12. The system as claimed in claim 11 wherein the signal processing unit identifies periodic patterns in the map of the difference between each pair of position measurements in the spatial domain.

13. The system as claimed in claim 12 wherein the signal processing unit minimizes the presence of periodic patterns in the map in order to reduce interpolation error and thereby correct the pairs of position measurements in the spatial domain.

14. The system as claimed in claim 13 wherein the encoder assembly comprises a single encoder head that is configured to simultaneously generate the first and second measurements for each pair of position measurements.

15. The system as claimed in claim 14 wherein the single encoder head is configured to simultaneously generate the first and second measurements using a single scale pitch.

16. A system for measuring movement along a travel path, the system comprising:
(a) an encoder assembly positioned relative to a main track, one of the encoder assembly and the main track being configured to move relative to the other along the travel path, the encoder assembly generating pairs of quadrature output signals based on the position of the encoder assembly relative to the main track; and
(b) a signal processing unit in electrical communication with the encoder assembly;
(c) wherein the signal processing unit calculates a position measurement in the time domain for the encoder assembly relative to the main track using each pair of quadrature output signals;
(d) wherein the signal processing unit converts each position measurement in the time domain into a corresponding position measurement in the spatial domain and creates a map of position measurements in the spatial domain within a grating period.

17. The system as claimed in claim 16 wherein the signal processing unit utilizes the map to identify and minimize the presence of gain, offset, and phase errors in the pair of quadrature output signals to yield a corrected pair of quadrature output signals, the signal processing unit recalculating and revising the position measurement in the time domain using the corrected pair of quadrature output signals.

18. The system as claimed in claim 17 wherein the signal processing unit calculates the position measurement in the time domain by computing an arctangent of a quotient of the pair of quadrature output signals.

19. The system as claimed in claim 18 wherein the signal processing unit uses a recursive approach to revise each position measurement in the spatial domain over a grating period, both over time and as one of the encoder assembly and the main track moves relative to the other.
